(19) United States
(12) Patent Application Publication
(10) Pub. No.: US 2011/0176743 A1
(43) Pub. Date: Jul. 21, 2011

(54) DATA COMPRESSION METHODS

(76) Inventors: Pathamadi V. SANKAR, Tustin, CA (US); Leonard Anthony Ferrari, Capitola, CA (US)

(21) Appl. No.: 12/987,873

(22) Filed: Jan. 10, 2011

Related U.S. Application Data
(60) Provisional application No. 61/297,235, filed on Jan. 21, 2010.
(60) Provisional application No. 61/316,665, filed on Mar. 23, 2010.

(51) Int. Cl. G06T 9/00

(52) U.S. Cl. 382/248; 382/232

(57) ABSTRACT

Data compression methods include an adaptive context sensitive compression (ACSC) method for data compression, a generalized discrete wavelength transform (GDWT) method for data compression, and a data compression method combining both the ACSC method and the GDWT method. The ACSC method improves upon the conventional CSC method with the development of a more informed adaptive estimate of the relative bandwidth, and hence the corresponding sampling rate, for each row of an image, rather than a global decimation rate for all the rows of the image. The GDWT method may be successful with N is an arbitrary number and may result in reduced computational complexity and reduced storage requirements, as compared to conventional DWT, when N is not a power of two.

### CROSS-REFERENCE TO RELATED APPLICATIONS

This application claims the benefit of U.S. Provisional Patent Application No. 61/297,235, filed Jan. 21, 2010, and U.S. Provisional Patent Application No. 61/316,665, filed Mar. 23, 2010, each of which is hereby incorporated in its entirety by reference.

### BACKGROUND OF THE INVENTION

1. Field of the Invention

The present invention relates generally to data compression.

2. Description of the Related Art

The underlying premise of a context sensitive compression method (CSC) is the concept of a dual layer data compression scheme as shown in FIG. 1. The encoder 100 of the context sensitive compression (external compression) method includes two subcomponents—(1) the preprocessor 102 which is primarily a context sensitive sampler, and (2) the encoder 104 of the internal compression method, as shown in FIG. 2A. Similarly, the context sensitive decoder 106 includes two components—(1) the decoder 108 of the internal compression method, and (2) a cubic spline interpolator 110, as shown in FIG. 2B.

The wavelet transform has become the default standard for data compression since it was inducted as part of the JPEG 2000 standards. Wavelets have been traditionally defined on uniformly sampled signals and have been extensively studied and characterized using Fourier Transforms. Three different multi-disciplinary approaches over the last two decades have all yielded similar results for the traditional wavelet transforms. However, each approach follows an entirely different reasoning mechanism.

Efficient transforms of discrete sequences are based on two fundamental concepts, namely “divide”, during which the original data sequence is split into two subsequences, and “conquer”, with the recursive application of the method on the subsequences. In the case of discrete wavelet transforms (DWTs), the data sequence is split into two subsequences—one including the samples with the odd index and the other with the even index. If the original sequence is a length of N, the subsequences are of a length N/2. The odd sequence is low pass filtered with a “prediction” step and the even sequence is high pass filtered with a “correction” step as defined in a conventional “lifting approach” interpretation of the input signal. The DWTs have been traditionally explained on the basis of a cascaded bank of low pass and high pass filters at multiple resolutions. The corrected even sequence (or the high pass filtered data) is left alone and the wavelet transform is recursively applied on the low pass filtered odd subsequence until it reduces to a single sample, as shown in FIG. 3.

The concept described in FIG. 3 works well as long as the length of the input is a power of two or the sequence is appended with zeros to make the length a power of two. The storage and computational complexity of the DWT using the “lifting approach” is O(2^{k}), wherein N=2^{k}. However, when N is not a power of two, the need to append zeros seems like an artifact imposed by the structure of the method.

### SUMMARY OF THE INVENTION

In accordance with one embodiment, a method for compressing data of an image includes: determining a sampling rate of data for each row of an image independently of other rows of the image; determining a compression ratio for each row of the image independently of other rows of the image; determining a decimation rate for each row of the image; determining an interpolation rate for each row of the image; and compressing the data based upon the sampling rate, the compression ratio, the decimation rate, and the interpolation rate to produce compressed data.

In accordance with a further embodiment, a method for the wavelet transform of a discrete sequence of an arbitrary length includes: splitting the discrete sequence in half, into an even sequence-even subsequence and an even sequence-odd subsequence, when the length of the discrete sequence is even; and splitting the discrete sequence in three parts, into an odd sequence-even subsequence, an odd sequence-odd subsequence, and an extra digit subsequence, when the length of the discrete sequence is odd. In one embodiment, the method includes: low pass filtering either the odd sequence-odd subsequence or the even sequence-odd subsequence; and recursively computing the discrete wavelet transform of the result of the low pass filtering. In one embodiment, the method includes: high pass filtering either the odd sequence-even subsequence or the even sequence-even subsequence. In one embodiment, the method includes leaving the extra digit subsequence as is. In one embodiment, the length of the discrete sequence is not a power of two.

In accordance with a further embodiment, a method for compressing data of an image includes: determining a sampling rate of data for each row of an image independently of other rows of the image; determining a compression ratio for each row of the image independently of other rows of the image; applying an external compression of each row of data based on the compression ratio to yield a discrete sequence; splitting the discrete sequence in half, into an even sequence-even subsequence and an even sequence-odd subsequence, when the length of the discrete sequence is even; splitting the discrete sequence in three parts, into an odd sequence-even subsequence, an odd sequence-odd subsequence, and an extra digit subsequence, when the length of the discrete sequence is odd; and generating compressed data.

Embodiments in accordance with the invention are best understood by reference to the following detailed description when read in conjunction with the accompanying drawings.

### BRIEF DESCRIPTION OF THE DRAWINGS

FIG. 1 is a block diagram of a CSC dual compression scheme according to the prior art;

FIG. 2A is a block diagram of a CSC external compression encoder according to the prior art;

FIG. 2B is a block diagram of a CSC external compression decoder according to the prior art;

FIG. 3 is a block diagram describing the concept of DWT according to the prior art;

FIG. 4 is a graph showing level crossings of a band pass signal;

FIG. 5 showing the compression ratio of the ACSC method according to exemplary embodiments of the present invention;

FIG. 6 shows an ACSC compression ratio for each row of an image according to exemplary embodiments of the present invention;

FIG. 7 shows a graph comparing the ACSC method of the present invention with conventional CSC and JPEG (5,3) DWT compression methods;

FIG. 8 shows a schematic drawing showing the concept of the generalized discrete wavelet transform (GDWT) according to an exemplary embodiment of the present invention;

FIG. 9 is a graph showing CPU time for conventional DWT methods compared to the GWDT method of the present invention;

FIG. 10 is a graph showing the average compression ratio and the average RMS percentage error for a set of images;

FIG. 11 is a graph showing the average compression ratio and the average RMS percentage error for a color image subset of the set of images of FIG. 10; and

FIG. 12 is a graph showing the average compression ratio and the average RMS percentage error for a fingerprint image subset of the set of images of FIG. 10.

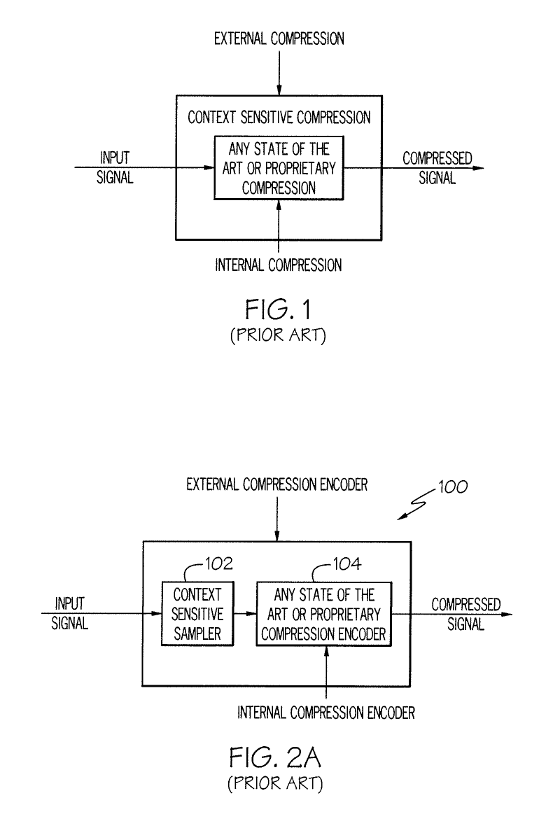

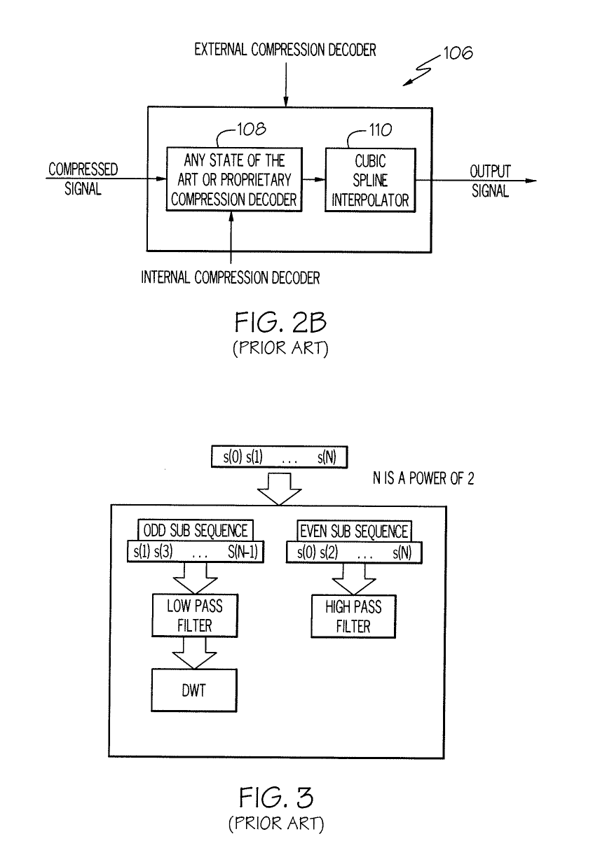

### DETAILED DESCRIPTION OF THE INVENTION

Broadly viewed, embodiments in accordance with the data compression methods include an adaptive context sensitive compression (ACSC) method for data compression, a generalized discrete wavelength transform (GDWT) method for data compression, and a data compression method combining both the ACSC method and the GDWT method. The ACSC method improves upon the conventional CSC method with the development of a more informed adaptive estimate of the relative bandwidth, and hence the corresponding sampling rate, for each row of an image, rather than a global decimation rate for all the rows of the image. When the length of the sequence, N, is a power of two, the GDWT method may yield results similar to conventional; however, when N is an arbitrary number, the GDWT method may result in reduced computational complexity and reduced storage requirements, as compared to conventional DWT, when N is not a power of 2.

### Adaptive Context Sensitive Compression Method

Unlike the conventional CSC method, which computes a sampling rate based on the mean level crossing estimate of all the rows of the image, the ACSC method estimates the sampling rate for each row independently of the other rows. In this scheme, the signal may be pre-sampled to “near Nuyquist Rate”, computed using a level crossing counting technique, for the estimation of the bandwidth of the signal. The optimally sub-sampled signal is them compressed using any standard compression technique, such as wavelet transform, including the generalized discrete wavelet transform method described in greater detail below.

Generally, the external compression (namely the preprocessor and the post processor) for the CSC and the ACSC are similar except that the decimation and interpolation rates for each row may differ for the ACSC method, while the decimation and interpolation rates are the same for the CSC method. The ACSC method results in the storage of an extra byte per row to save the decimation ratio for each row of the ACSC method, while a single byte suffices for the CSC method for the whole image.

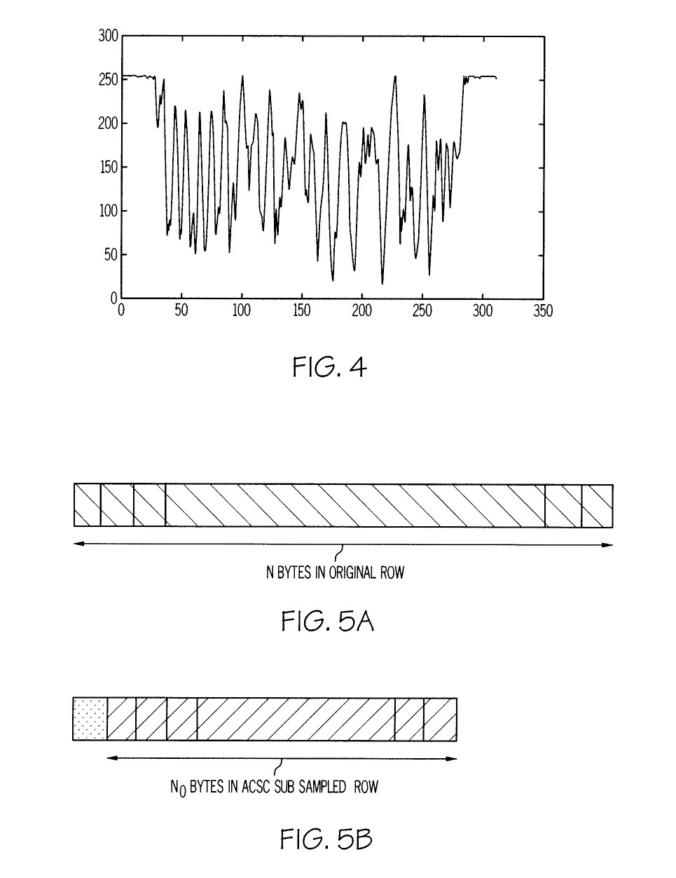

The information in a band pass signal is uniquely characterized by the zeros (zero crossings as well as complex zeros) of the signals. This is a fundamental limit, similar to Shannon's sampling method. As shown in FIG. 4, the signal may have 512 samples, but has approximately 39 mean level crossings. In principle, this could lead to a compression ratio of 512/39 or 13.13, provided there are no complex zeros, which do not reveal as real zero crossings.

A theoretical formula for estimating the center frequency of a normal process is shown in Formula (I)

λ₀²=4(f₀²+σ²) (I)

where

λ₀=zero crossing rate;

f₀—center frequency; and

σ=bandwidth.

The formula for the bandwidth of a normal process is given by Formula (II).

σ=0.88λ (II)

where

λ=(1/average interval between successive level crossings);

N₀=floor (N(0.88λ)/4); and

N₀ is the optimal number of samples and N is the original number of samples.

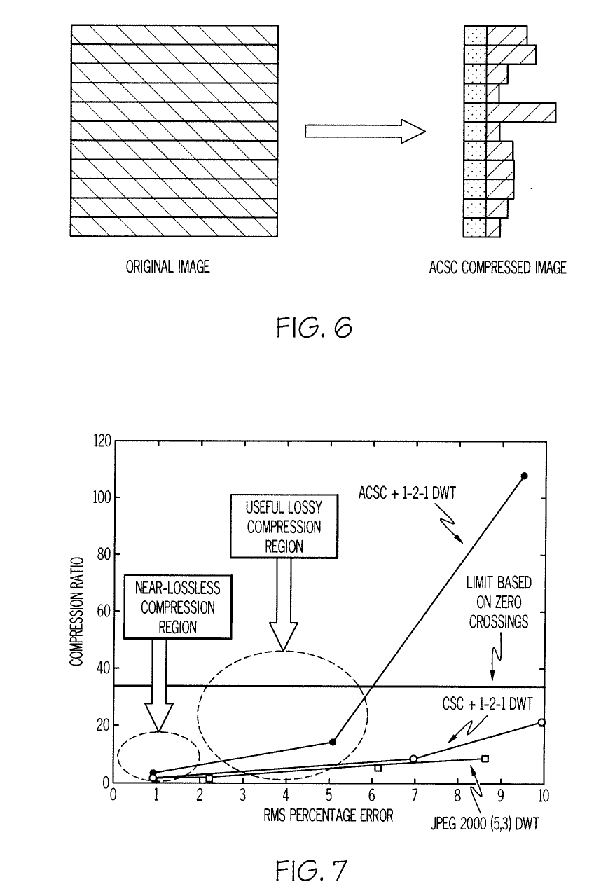

For each row of the image, an optimal number of samples may be estimated and the signal is sub-sampled. For instance, in FIG. 5, the optimal sampling rate is given by N₀ and the compression ratio by (N/(N₀+1). For the entire image, the optimal number of samples for each row could vary as shown in FIG. 6. While FIG. 6 shows each row being separately compressed, the compression could be carried out on a column-by-column basis as an alternative method. Therefore, as used here within, the term “row”, as used in the context of a row of an image, may refer to either a horizontal row or a vertical row (column) of the image.

An initial experiment was conducted to compare the conventional CSC method (whole image decimation and interpolation rates) with the ACSC method (decimation and interpolation rates based on individual rows of the image). The effective compression ratio for both the external and internal compression methods are given by the product of the compression ratios of both the external and internal compression methods. It should be noted that the internal compression method can be any state of the art compression method, such as the JPEG 2000 method.

The ACSC method was applied to 20 images. Initial experiments showed that the ACSC method provides a higher compression ratio at the same or similar interpolation error rates. Table 1 summarizes the average compression ratios for both ACSC and CSC and the JPEG 2000 (5,3) DWT methods for three different error rates. The data from Table 1 is plotted in the graph of FIG. 7.

TABLE 1
Average Compression Ratios and Percentage
RMS Errors for ACSC and CSC

| Method | | 1 | 2 | 3 |
|---|---|---|---|---|
| JPEG 2000 | Compression | 1.3 | 2.2 | 3.0 |
| (5, 3) DWT | Ratio | | | |
| | RMS Error | 2.2% | 6.0% | 8.6% |
| CSC + 1-2-1 | Compression | 0.9 | 6.9 | 20.1 |
| DWT | Ratio | | | |
| | RMS Error | 0.0% | 6.9% | 10.0% |
| ACSC + 1-2-1 | Compression | 1.5 | 13.6 | 107.7 |
| DWT | Ratio | | | |
| | RMS Error | 0.8% | 5.8% | 9.4% |

For a lunarscape image, the ACSC method provides a compression ratio of 35 as opposed to 3.92 for the JPEG 2000 method and 15 for the CSC method. A fingerprint image results in an ACSC compression ratio of 10 as opposed to 6.45 for the CSC method and almost 3 for the JPEG 2000 method. Similarly, an urban scene image results in an ACSC compression ratio of 5.98 as opposed to 5.6 for the CSC method and 2.35 for the JPEG 2000 method.

The ACSC method described above is a sensor agnostic approach which will work on any digitized data, independent of the sensor wavelength or length of time (large amounts of data). The ACSC method will work with any state of the art or custom method, since the ACSC is an external compression with pre and post processing stages. The ACSC method can generally result in from about 50% to about 1000% improvement in data compression over the state of the art technology.

### Generalized Discrete Wavelength Transform (GDWT)

As discussed above, the GDWT method may produce results similar to the conventional DWT when the length of the sequence, N, is a power of two. However, when N is an arbitrary number, GDWT may result in reduced computational complexity and reduced storage requirements, as compared to conventional DWT, when N is not a power of 2.

Assuming now that the length, N, of an arbitrary sequence s is not a power of two, then N is either odd or even. If N is even, then the sequence can be split into two halves (odd {s(2*(k−1)+1)} and even {s(2*k)}sequences) just as in the traditional DWT approach. However, if N is an odd number, then the sequence can be split into three sequences as shown in FIG. 8, namely an odd sequence {s(0), s(2) . . . , s(N−2)}, an even sequence {s(1), s(3), . . . , s(N−1)} and an extra digit {s(N)}. The odd subsequence is low pass filtered and passed on to the next stage for the recursive computation of its DWT. The even subsequence is high pass filtered and then left alone and is not further processed. The third subsequence of the extra digit is left as it is (all pass filtered) as part of the final transform.

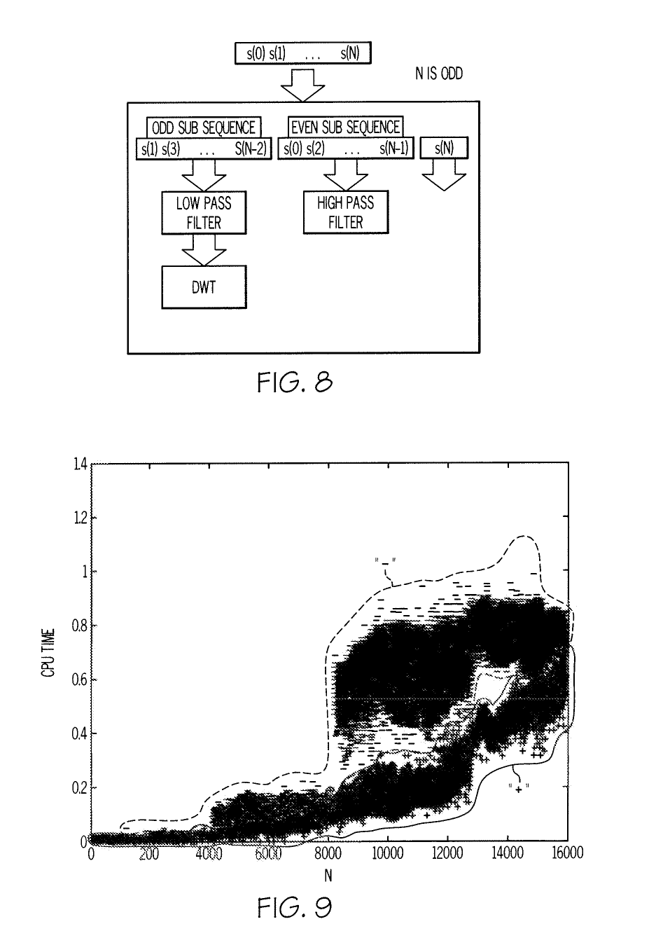

Let k=ceiling(log₂N) such that 2^{(k-1)}<=N<=2^{k}. The complexity of the GDWT is O(N) while that of the DWT is O(2^{ceiling(log 2N))}) FIG. 9 shows a comparison of the CPU time of implementations of conventional DWT and GDWT, according to an embodiment of the present invention, on a random sequence of digits for n=1 to 16000. The GDWT CPU times are shown by plus signs and the DWT CPU times are shown in minus signs. It can be seen that the GDWT is more efficient than the DWT and is similar in performance to the DWT when N is a power of two.

As shown in FIG. 9, the DWT (minus sign) execution times are much higher than the GDWT (plus sign) execution times for random data sequences of length ranging from 1 to 16000 data points. Thus, generally, GDWT, at best, is twice as fast as the DWT and at worst is substantially similar to the speed of DWT depending on the value of N, where GDWT is substantially similar to DWT when N is a power of 2, an occurrence that happens for 13 values (2, 4, 8, 16, 32, 64, 128, 256, 512, 1024, 2048, 4096 and 8192) among the first 16,000 numbers. Similarly, generally the storage requirements for GDWT are, at best, about half that of DWT and, at worst, substantially similar to DWT. Whenever, N is a power of two, the plus signs and minus signs of FIG. 9 coincide.

The GDWT is a recursive method as described below. The lines with a “*” on the left margin are operations utilized by the GDWT method as compared to DWT. If either of those steps is removed or N is a power of two, the results of GDWT are similar to DWT. If the signs of M₁ and M₂ are given negative values with the same magnitude, the forward GDWT becomes the inverse GDWT.

```
f=gdwt(s,M₁,M₂)
% s is the input signal and f is the output GDWT.
M₁ and M₂ define the type of wavelet transform
N=length(s);
if ( N is 1) { f(1) = s(1) return}
---------------------------- Split into two or three subsequences-------------------------------
if ( N is even );
{ set sₑᵥₑₙ={s(0),s(2) ...s(N)}; s_{odd}= {s(1),s(2) ...s(N−1)} }
* if ( N odd )
* { set sₑᵥₑₙ ={s(0),s(2) ...s(N)}; s_{odd} = {s(1),s(2) ...s(N−1); send={s(N)}} }
-------------------- High Pass Filtered or Corrected Even Subsequence-----------------------
for k=1: (floor(N/2)−1) { sₑᵥₑₙ (k) = sₑᵥₑₙ (k) − M₁( s_{odd} (k)+ s_{odd} (k+1) }
  * if ( N is odd )
  *  { sₑᵥₑₙ (floor(N/2)) = sₑᵥₑₙ (floor(N/2)) − M₁( s_{odd} (floor(N/2))+s s_{odd} (ceiling(N/2))}
if ( N is even )
    { sₑᵥₑₙ (floor(N/2)) = sₑᵥₑₙ (floor(N/2)) − M₁( s_{odd} (floor(N/2))+ s_{odd} (1)}
------------------- Low Pass Filtered or Predicted Odd Subsequence--------------------------
s_{odd} (1) = s_{odd} (1) + M₂ ( sₑᵥₑₙ (floor(N/2))+ sₑᵥₑₙ (1)}
for k=2: (floor(N/2)) { s_{odd} (k) = s_{odd} (k) − M₂(sₑᵥₑₙ (k−1)+ sₑᵥₑₙ (k) }
------------------------- All Pass Filtered or Undisturbed Last digit-------------------------------
  * if ( N is odd ) { s_{odd} (floor(N/2)) = s(N) }
f={gdwt(s_{odd} ), sₑᵥₑₙ }
```

Table 2 below defines the values of M₁ and M₂ for a class of wavelet transforms.

TABLE 2
Class of Wavelet Transforms

| Forward Wavelet Transform | M₁ | M₂ |
|---|---|---|
| 1-2-1 cubic spline | ½ | ½ |
| JPEG 2000 (5, 3) filter | ½ | ¼ |
| Daubechies (2, 2) filter | ¼(√3 − √3 − 2) | √3 |
| Inverse Wavelet Transform | M₁ | M₂ |
| 1-2-1 cubic spline | −½ | −½ |
| JPEG 2000 (5, 3) filter | −½ | −¼ |
| Daubechies (2, 2) filter | −¼(√3 − √3 − 2) | −√3 |

### Combined GDWT and ACSC

In one embodiment, the ACSC external compression method described above may be combined with the generalized discrete wavelet transform method.

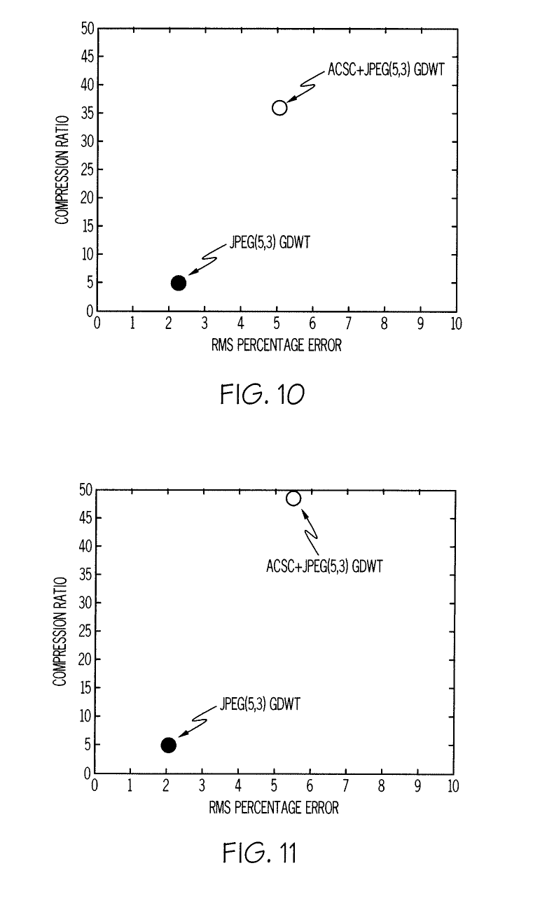

DWT, ACSC+DWT and ACSC+GDWT methods were applied on a set of 14 images, of which eight were fingerprint images and six were color images. The compression ratios and the RMS percentage errors are given in Table 3 and in FIGS. 10 through 12.

TABLE 3
Compression Ratio versus RMS Percentage Error

| | JPEG (5, 3) DWT | | ACSC + JPEG (5, 3) GDWT | |
|---|---|---|---|---|
| | Compression | RMS | Compression | RMS |
| Image Type | Ratio | Error | Ratio | Error |
| Fingerprints | 4.98 | 2.35% | 25.02 | 4.78% |
| Color | 5.42 | 2.14% | 49.23 | 5.44% |
| All | 5.17 | 2.26% | 35.39 | 5.06% |

FIG. 10 demonstrates that the ACSC+JPEG (5,3) filter method outperforms the JPEG (5,3) filter DWT method for the overall compression ratio for the entire set of 14 images.

FIG. 11 shows that the ACSC+JPEG (5,3) filter GDWT method outperforms JPEG (5,3) filter DWT method for the compression ratio for a subset of images including the six color images.

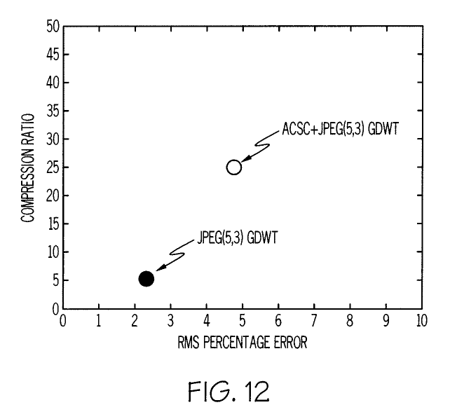

FIG. 12 shows that the ACSC+JPEG (5,3) filter GDWT method outperforms JPEG (5,3) filter DWT method for the compression ratio for a subset of images including the eight fingerprint images.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

Some portions of the above-description may present portions of the invention in terms of algorithms and symbolic representations of operation, or algorithm-like representations, of operations on data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing devices.

Further portions of the invention include operations in an algorithmic-like form. It should be noted that the operations and instructions can be embodied in software, firmware and/or hardware, and when embodied in software, can be downloaded to reside on and operated from different platforms used by real time network operating systems.

Embodiments in accordance with the invention can be embodied as a computer program product that can be accessed by a computer device or other devices. Herein a computer program product is a medium configured to store or transport computer readable code. Some examples of computer program products are CD-ROM discs, DVD-ROM discs, floppy discs, magnetic tapes, computer hard drives, server systems, such as server system 140, or other media forms capable of delivering computer readable data representing computer readable code.

Those of skill in the art will readily recognize that the embodiments presented herein are not inherently related to any particular computer device, computer architecture, computer or industry standard, or any other specific apparatus.

We claim:

1. A method for compressing data of an image comprising:
determining a sampling rate of data for each row of an image independently of other rows of the image;
determining a compression ratio for each row of the image independently of other rows of the image;
determining a decimation rate for each row of the image independently of other row of the image;
determining an interpolation rate for each row of the image independently of other rows of the image; and
compressing the data of the image based on the sampling rate, compression ratio, decimation rate and interpolation rate to produce compressed data.

2. The method of claim 1, further comprising:
estimating a mean level of the data.

3. The method of claim 2, further comprising:
calculating a number of mean level crossings for each row of the image.

4. The method of claim 3, further comprising:
estimating the bandwidth for each row of the image.

5. The method of claim 4, further comprising:
generating a sub-sampled row of the image based on the number of mean level crossings and the estimation of the bandwidth for each row of the image.

6. The method of claim 5, further comprising:
adding a byte to each row of the image, the byte representing a compression ratio for a discrete row of the image.

7. The method of claim 6, further comprising:
compressing the sub-sampled row of the image.

8. The method of claim 7, wherein the compressing the sub-sampled row of the image is carried out using a 2-5-2 cubic spline discrete wavelet transform, a 1-2-1 cubic spline discrete wavelet transform, a JPEG 2000 (5,3) discrete wavelet transform, or a Daubecheiss (2,2) discrete wavelet transform.

9. The method of claim 7, wherein the compressing the sub-sampled row of the image is carried out using a generalized discrete wavelet transform suitable for a discrete sequence of an arbitrary length.

10. A method for the wavelet transform of a discrete sequence of an arbitrary length comprising:
splitting the discrete sequence in half, into an even sequence-even subsequence and an even sequence-odd subsequence, when the length of the discrete sequence is even; and
splitting the discrete sequence in three parts, into an odd sequence-even subsequence, an odd sequence-odd subsequence, and an extra digit subsequence, when the length of the discrete sequence is odd.

11. The method of claim 10, further comprising:
low pass filtering either the odd sequence-odd subsequence or the even sequence-odd subsequence; and
recursively computing the discrete wavelet transform of the result of the low pass filtering.

12. The method of claim 10, further comprising:
high pass filtering either the odd sequence-even subsequence or the even sequence-even subsequence.

13. The method of claim 10, further comprising:
leaving the extra digit subsequence as is.

14. The method of claim 10, wherein the length of the discrete sequence is not a power of two.

15. A method for compressing data of an image comprising:
determining a sampling rate of data for each row of an image independently of other rows of the image;
determining a compression ratio for each row of the image independently of other rows of the image;
applying an external compression to each row of data based on the compression ratio to yield a discrete sequence;
splitting the discrete sequence in half, into an even sequence-even subsequence and an even sequence-odd subsequence, when the length of the discrete sequence is even;
splitting the discrete sequence in three parts, into an odd sequence-even subsequence, an odd sequence-odd subsequence, and an extra digit subsequence, when the length of the discrete sequence is odd; and
generating compressed data.

16. The method of claim 15, further comprising:
estimating a mean level of the data;
calculating a number of mean level crossings for each row of the image;
estimating the bandwidth for each row of the image; and
generating the discrete sequence based on the number of mean level crossings and the estimation of the bandwidth for each row of the image.

17. The method of claim 15, further comprising:
low pass filtering either the odd sequence-odd subsequence or the even sequence-odd subsequence; and
recursively computing the discrete wavelet transform of the result of the low pass filtering.

18. The method of claim 15, further comprising:
high pass filtering either the odd sequence-even subsequence or the even sequence-even subsequence.

19. The method of claim 15, further comprising:
leaving the extra digit subsequence as is.

20. The method of claim 15, wherein the length of the discrete sequence is not a power of two.
